(19) United States
(12) Patent Application Publication
(10) Pub. No.: US 2026/0038824 A1
(43) Pub. Date: Feb. 5, 2026

(54) POSITIVE ELECTRODE ACTIVE MATERIAL, MANUFACTURING METHOD OF POSITIVE ELECTRODE ACTIVE MATERIAL, AND BATTERY

(71) Applicant: TOYOTA JIDOSHA KABUSHIKI KIAISHA, Toyota-shi (JP)

(72) Inventor: Shin USHIRODA, Susono-shi (JP)

(73) Assignee: TOYOTA JIDOSHA KABUSHIKI KIAISHA, Toyota-shi (JP)

(21) Appl. No.: 19/229,288

(22) Filed: Jun. 5, 2025

(30) Foreign Application Priority Data
Aug. 5, 2024 (JP) 2024-129170

(51) Int. Cl. H01M 4/505; C01G 53/51; C01G 53/66; H01M 10/054

(52) U.S. Cl. CPC H01M 4/505; C01G 53/51; C01G 53/66; H01M 10/054; C01P 2002/54; C01P 2002/77; C01P 2006/40

(57) ABSTRACT

The disclosure relates to a positive electrode active material, a manufacturing method of a positive electrode active material, and a battery. The positive electrode active material of the present disclosure includes an Na-containing oxide. The Na-containing oxide has a P2-type structure. The Na-containing oxide includes, as constituent elements, at least: Na; Ca; at least one transition metal element among Mn, Ni, and Co; and O.

### CROSS-REFERENCE TO RELATED APPLICATION

This application claims priority to Japanese Patent Application No. 2024-129170 filed on Aug. 5, 2024. The disclosure of the above-identified application, including the specification, drawings, and claims, is incorporated by reference herein in its entirety.

### BACKGROUND

### 1. Technical Field

This application discloses a positive electrode active material, a manufacturing method of a positive electrode active material, and a battery.

### 2. Description of Related Art

Japanese Unexamined Patent Application Publication No. 2023-182443 (JP 2023-182443 A) discloses a positive electrode active material that is used for a sodium ion battery and has a P2-type structure. Meanwhile, J. Am. Chem. Soc. 2020, 142, 5742-5750 discloses a technology that increases the amount of Na included in a positive electrode active material having a P2-type structure.

### SUMMARY

Conventional positive electrode active materials having a P2-type structure have room for improvement in terms of cycle characteristics.

This application discloses the following aspects as means for solving the above challenge.

### Aspect 1

A positive electrode active material including an Na-containing oxide,
wherein the Na-containing oxide has a P2-type structure, and
wherein the Na-containing oxide includes, as constituent elements, at least:
   Na;
   Ca;
   at least one transition metal element among Mn, Ni, and Co; and
   O.

### Aspect 2

The positive electrode active material according to Aspect 1,
wherein an amount of Na included in the Na-containing oxide may be 0.65 mol or more and less than 0.80 mol per mole of the Na-containing oxide, and
wherein an amount of Ca included in the Na-containing oxide may be more than 0 mol and 0.075 mol or less per mole of the Na-containing oxide.

### Aspect 3

The positive electrode active material according to Aspect 1 or 2, wherein the Na-containing oxide may include, as constituent elements, at least Na, Ca, Mn, Ni, and O.

### Aspect 4

A manufacturing method of a positive electrode active material, comprising:
obtaining a solid mixture including a precursor, an Na source, and a Ca source; and
obtaining an Na-containing oxide having a P2-type structure by firing the solid mixture,
   wherein the precursor includes at least one transition metal element among Mn, Ni, and Co.

### Aspect 5

A battery having a positive electrode active material layer, an electrolyte layer, and a negative electrode active material layer, wherein the positive electrode active material layer includes the positive electrode active material according to any one of Aspects 1 to 3.

The positive electrode active material of the present disclosure has excellent cycle characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows one example of a flow of a manufacturing method of a positive electrode active material;

FIG. 2 schematically shows one example of the configuration of a battery; and

FIG. 3 shows a relationship between an interlayer distance of Na layers in a P2-type structure and a Ca doping amount.

### DETAILED DESCRIPTION OF EMBODIMENTS

### 1. Positive Electrode Active Material

A positive electrode active material according to one embodiment includes an Na-containing oxide. The Na-containing oxide has a P2-type structure. The Na-containing oxide includes, as constituent elements, at least: Na; Ca; at least one transition metal element among Mn, Ni, and Co; and O.

### 1.1 Crystal Structure

The Na-containing oxide included in the positive electrode active material has at least the P2-type structure (which belongs to space group P63mc) as a crystal structure. In addition to having the P2-type structure, the Na-containing oxide may have a crystal structure other than the P2-type structure. Examples of crystal structures other than the P2-type structure include various crystal structures (a P3-type structure etc.) that are formed when Na is inserted into and desorbed from the P2-type structure. The Na-containing oxide may have the P2-type structure as a main phase. The crystal structure constituting the main phase of the Na-containing oxide can vary according to a charge-discharge state.

The size of crystallites of the Na-containing oxide included in the positive electrode active material is not particularly limited. In the Na-containing oxide, one crystallite may form one particle by itself, or one particle may be formed by a plurality of crystallites. In other words, the positive electrode active material according to one embodiment may be (1) a single-crystal particle that is present independently, (2) an aggregate (secondary particle) of a plurality of single-crystal particles, (3) a polycrystalline particle including a plurality of crystallites, or (4) an aggregate (secondary particle) of a plurality of polycrystalline particles. In particular, when the Na-containing oxide constitutes a polycrystalline particle, especially when it constitutes a spherical polycrystalline particle, even higher performance of the positive electrode active material is likely to be secured. The P2-type structure is a hexagonal system, in which the diffusion coefficient of Na ions is high and crystals tend to grow in one specific direction. Therefore, crystallites having the P2-type structure are typically ones of which the crystal growth direction is disproportionately one specific direction (e.g., plate-shaped ones). In this case, end portions (end portions in the aforementioned crystal growth direction) of the crystallites of the P2-type structure are likely to become inlets and outlets for intercalation. In other words, when the Na-containing oxide constitutes polycrystalline particles, effects can be expected such as an effect that the reaction resistance decreases as the numbers of inlets and outlets for intercalation included in one particle increase, an effect that the diffusion resistance decreases as the travel distance of sodium ions becomes shorter, and an effect that the amount of expansion and contraction of the particles as a whole during charge and discharge becomes smaller. For example, the diameter of the crystallites constituting the Na-containing oxide may be 0.1 μm or larger and 5.0 μm or smaller, 0.5 μm or larger and 4.0 μm or smaller, or 1.0 μm or larger and 3.0 μm or smaller. “Crystallites” and “the diameter of the crystallites” can be obtained by observing the external appearance etc. of the Na-containing oxide under a scanning electron microscope (SEM) or a transmission electron microscope (TEM). That is, when the Na-containing oxide is observed and one closed region surrounded by a crystal boundary is observed, this region is regarded as a “crystallite”. A maximum Feret's diameter of this crystallite is obtained, and the obtained diameter is regarded as “the diameter of the crystallite”. When the Na-containing oxide is formed by a single crystal, this single crystal itself can be called one crystallite, and a maximum Feret's diameter of this single crystal is “the diameter of the crystallite”. Alternatively, the diameter of the crystallite can be obtained by EBSD or XRD. For example, the diameter of the crystallite can be obtained from a half-value width of a diffraction line of an XRD pattern based on Scherrer's formula. When the diameter of the crystallite determined by any one of these methods is within the aforementioned range, the Na-containing oxide is likely to exhibit higher performance. The crystallites constituting the Na-containing oxide may have a first face that is exposed in a surface of the oxide, and this first face may be planar.

As described above, the crystallite of the Na-containing oxide having the P2-type structure tends to assume a plate-like shape. That is, the Na-containing oxide having the P2-type structure can be a plate-shaped particle as well as can be a spherical particle as small plate-shaped crystallites couple to one another. In other words, the Na-containing oxide as a whole may constitute a plate-shaped single-crystal particle or may constitute a spherical polycrystalline particle. The spherical polycrystalline particle has a plurality of crystallites on its surface. When the Na-containing oxide constitutes a spherical polycrystalline particle, the degree of flexion is reduced due to the spherical shape, which seems to reduce the sodium ion conduction resistance. Thus, for example, the battery is likely to have improved rate characteristics and a higher reversible capacity. In this application, “spherical particle” means a particle with a degree of circularity of 0.80 or higher. The degree of circularity of the particle may be 0.81 or higher, 0.82 or higher, 0.83 or higher, 0.84 or higher, 0.85 or higher, 0.86 or higher, 0.87 or higher, 0.88 or higher, 0.89 or higher, or 0.90 or higher. The degree of circularity of the particle is defined by 4πS/L². Here, S is an orthographic projection area of the particle, and L is the perimeter of an orthographic projection image of the particle. The degree of circularity of the particle can be obtained by observing the external appearance of the particle under a scanning electron microscope (SEM), a transmission electron microscope (TEM), or an optical microscope.

### 1.2 Chemical Composition

The Na-containing oxide included in the positive electrode active material includes, as constituent elements, at least: Na; Ca; at least one transition metal element among Mn, Ni, and Co; and O. In particular, when the Na-containing oxide includes, as constituent elements, at least: Na; Ca; Mn; one or both of Ni and Co; and O, especially when it includes, as constituent elements, at least Na, Ca, Mn, Ni, and O, higher performance is likely to be obtained. Or also when the Na-containing oxide includes, as constituent elements, at least Na, Ca, Mn, Fe, and O, higher performance is likely to be obtained.

The amount of Na included in the Na-containing oxide is not particularly limited, and may be, for example, per mole of the Na-containing oxide, 0.60 mol or more (0.60≤Na/O₂), 0.65 mol or more, or 0.70 mol or more, and 1.40 mol or less, 1.30 mol or less, 1.20 mol or less, 1.10 mol or less, 1.00 mol or less, 0.90 mol or less, or less than 0.80 mol. In other words, the Na-containing oxide may include, relative to one mol of O, 0.30 mol or more, 0.325 mol or more, or 0.35 mol or more Na, and 0.70 mol or less, 0.65 mol or less, 0.60 mol or less, 0.55 mol or less, 0.50 mol or less, 0.45 mol or less, or less than 0.40 mol Na. In particular, when the amount of Na included in the Na-containing oxide is 0.65 mol or more and less than 0.80 mol per mole of the Na-containing oxide, a high capacity is likely to be secured.

The Na-containing oxide includes at least Ca as an additive element. Na layers in the P2-type structure of the Na-containing oxide can be doped with Ca. Conventional Na-containing oxides have an issue that the Na layers in the P2-type structure collapse after desorption of Na, and the amounts of Na to be inserted and desorbed thereafter decrease, resulting in degradation of the cycle characteristics. As far as the present inventor confirmed, increasing the amount of Na included in the Na-containing oxide did not always allow for a sufficient capacity. As a solution, in this embodiment, the Na-containing oxide includes Ca, and as this Ca functions as a pillar, collapse of the Na layers is likely to be mitigated even after desorption of Na, and consequently excellent cycle characteristics are likely to be secured. Further, as this Ca functions as a pillar and mitigate collapse of the Na layers, the amounts of Na to be inserted and desorbed increases, and consequently a higher capacity can be secured. The amount of Ca included in the Na-containing oxide is not particularly limited, and can be adjusted as appropriate according to target active material performance. For example, the amount of Ca included in the Na-containing oxide may be, per mole of the Na-containing oxide, more than 0 mol and 0.090 mol or less (0<Ca/O₂≤0.090), more than 0 mol and 0.085 mol or less, more than 0 mol and 0.080 mol or less, more than 0 mol and 0.075 mol or less, more than 0 mol and 0.070 mol or less, more than 0 mol and 0.065 mol or less, more than 0 mol and 0.060 mol or less, more than 0 mol and 0.055 mol or less, more than 0 mol and 0.050 mol or less, more than 0 mol and 0.045 mol or less, or more than 0 mol and 0.040 mol or less. In particular, when the amount of Ca included in the Na-containing oxide is more than 0 mol and 0.075 mol or less (0<Ca/O₂≤0.075) per mole of the Na-containing oxide, a higher capacity as well as excellent cycle characteristics is likely to be secured.

The Na-containing oxide includes at least one or more among Mn, Ni, and Co as transition metal elements. In particular, when the Na-containing oxide includes, as transition metal elements, at least Mn and one or both of Ni and Co, especially when it includes at least Mn and Ni, higher performance is likely to be obtained. The amount of transition metal element included in the Na-containing oxide is not particularly limited as long as the P2-type structure can be maintained.

The Na-containing oxide may have a chemical composition expressed by Naₐ₋₂ₚCaₚMn_{x-α}Ni_{y-β}Co_{z-γ}M_{α+β+γ}O₂ (where 0.8≤a≤1.4, 0<p≤0.090, x+y+z=1.0, 0≤α+β+γ≤0.20, and M is at least one type selected from B, Mg, Al, K, Ti, V, Cr, Cu, Zn, Ga, Ge, Sr, Y, Zr, Nb, Mo, and W). In this chemical composition, a is 0.8 or more and 1.4 or less, and may be 1.3 or less, 1.2 or less, 1.1 or less, or 1.0 or less. The value of p is more than 0 and 0.090 or less, and may be 0.085 or less, 0.080 or less, 0.075 or less, 0.070 or less, 0.065 or less, 0.060 or less, 0.055 or less, 0.050 or less, 0.045 or less, or 0.040 or less. The value of x is 0 or more and may be 0.10 or more, 0.20 or more, 0.30 or more, 0.40 or more, 0.50 or more, or 0.60 or more, and is 1.00 or less and may be 0.90 or less, 0.80 or less, or 0.70 or less. The value of y is 0 or more and may be 0.10 or more, 0.20 or more, or 0.30 or more, and is 1.00 or less and may be 0.90 or less, 0.80 or less, 0.70 or less, 0.60 or less, 0.50 or less, or 0.40 or less. The value of z is 0 or more and 1.00 or less and may be 0.90 or less, 0.80 or less, 0.70 or less, 0.60 or less, 0.50 or less, 0.40 or less, 0.30 or less, 0.20 or less, or 0.10 or less. The additive element M has a function of stabilizing the P2-type structure (e.g., a function of mitigating elution of transition metal elements) by being inserted into transition metal layers in the P2-type structure. In the above-described chemical composition, when α+β+γ is 0 or more and 0.20 or less, an especially high capacity is likely to be secured. The value of α+β+γ may be 0.01 or more, 0.02 or more, 0.03 or more, 0.04 or more, or 0.05 or more, and may be 0.19 or less, 0.17 or less, 0.15 or less, 0.13 or less, 0.11 or less, 0.10 or less, 0.09 or less, 0.07 or less, 0.06 or less, 0.05 or less, 0.04 or less, or 0.03 or less. Or the Na-containing oxide may have a chemical composition expressed by Naₐ₋ₚCaₚMnₓNi_{y}Co_{z}O₂ (i.e., a chemical composition with the aforementioned α+β+γ being 0). While the composition ratio of O is almost 2, it is not limited to being exactly 2.0 and is variable.

### 1.3 Others

The positive electrode active material according to one embodiment may be composed only of the above-described Na-containing oxide, or may be a combination of the above-described Na-containing oxide and another active material. The positive electrode active material according to one embodiment may be, for example, solid particles, or may be hollow particles, or may be particles with voids. While the size of the particles of the positive electrode active material is not particularly limited, a smaller size is considered to be more advantageous. For example, the mean particle diameter (D50) of the particles of the positive electrode active material may be 0.1 μm or larger and 10 μm or smaller, 1.0 μm or larger and 8.0 μm or smaller, or 2.0 μm or larger and 6.0 μm or smaller. The mean particle diameter (D50) is a particle diameter (D50, a median diameter) at an integrated value of 50% in a volume-based particle size distribution obtained by a laser diffraction scattering method.

### 2. Manufacturing Method of Positive Electrode Active Material

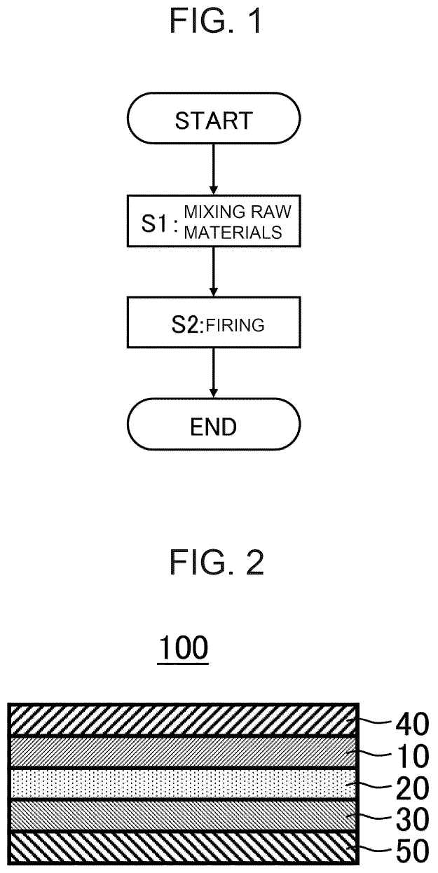

As shown in FIG. 1, a manufacturing method of the positive electrode active material according to one embodiment includes:
S1: obtaining a solid mixture including a precursor, an Na source, and a Ca source; and
S2: obtaining an Na-containing oxide having the P2-type structure by firing the solid mixture.

Here, the precursor includes at least one transition metal element among Mn, Ni, and Co.

### 2.1 S1

In S1, the precursor may be a salt including at least one element among Mn, Ni, and Co. For example, the precursor may be at least one type among carbonate, sulfate, nitrate, and acetate. Or the precursor may be a compound other than salts. For example, the precursor may be a hydroxide. The precursor may be a hydrate. The precursor may be a combination of multiple types of compounds. The precursor may have various shapes. For example, the precursor may have a particulate shape, or may be a spherical particle as will be described later. The particle diameter of the particle formed by the precursor is not particularly limited. The composition of the precursor can be determined as appropriate so as to correspond to the composition of the Na-containing oxide that is a final product.

In S1, the precursor may be obtained as follows: Using an ion source that can form a precipitate with a transition metal ion in an aqueous solution, and a transition metal compound including at least one transition metal element among Mn, Ni, and Co, a precipitate as the precursor may be obtained by a coprecipitation method. Thus, a spherical particle as the precursor is likely to be obtained. “An ion source that can form a precipitate with a transition metal ion in an aqueous solution” may be, for example, at least one type selected from a sodium salt such as sodium carbonate or sodium nitrate, sodium hydroxide, and sodium oxide. The transition metal compound may be the aforementioned salt, hydroxide, etc. including at least one element among Mn, Ni, and Co. Specifically, in S1, a precipitate as the precursor may be obtained by turning each of the ion source and the transition metal compound into a solution and dripping and mixing together these solutions. In this case, as the solvent, for example, water is used. In this case, various sodium compounds can be used as the base, and an aqueous ammonia solution or the like may be added to adjust the basicity. In the case of the coprecipitation method, a precipitate as the precursor can be obtained by, for example, preparing an aqueous solution of the transition metal compound and an aqueous solution of sodium carbonate and dripping and mixing together these solutions. Or the precursor can also be obtained by a sol-gel method.

In S1, the Na source may be any compound that includes Na. The Na source may be, for example, an Na salt such as carbonate or sulfate, or may be an Na compound such as sodium oxide or sodium hydroxide. In one embodiment, the Na source may be sodium carbonate.

In S1, the Ca source may be any compound that includes Ca. The Ca source may be, for example, a Ca salt such as carbonate or sulfate, or may be a Ca compound such as calcium oxide or calcium hydroxide. In one embodiment, the Ca source may be one or both of calcium oxide and calcium hydroxide.

In S1, at least the above-described precursor, the Na source, and the Ca source are mixed together to obtain a solid mixture including these. Means for mixing the precursor, the Na source, and the Ca source together is not particularly limited, and these may be manually mixed together using a mortar or the like, or may be mechanically mixed together using various mixing devices. In S1, the mixing ratio of the precursor, the Na source, and the Ca source can be determined as appropriate according to the composition of the Na-containing oxide that is the final product. For example, the amount of Na source to be mixed in relative to the precursor can be determined taking into account an amount of Na to be lost during the subsequent firing.

### 2.2 S2

In S2, the solid mixture obtained by SI is fired to obtain an Na-containing oxide having the P2-type structure. That is, in this embodiment, the Na-containing oxide having the P2-type structure can be obtained by a so-called solid phase method. In S2, the solid mixture may be optionally molded and optionally subjected to preliminary firing before being subjected to main firing.

In S2, the molding method of the solid mixture is not particularly limited. The solid mixture may be molded into pellets by commonly known molding means.

In S2, the preliminary firing of the solid mixture may be performed at a temperature not higher than that of the main firing. For example, the preliminary firing can be performed at a temperature lower than 700° C. The preliminary firing time is not particularly limited. Or the preliminary firing may be skipped.

In S2, the main firing of the solid mixture may be performed at a temperature of, for example, 700° C. or higher and 1100° C. or lower. The temperature is preferably 800° C. or higher and 1000° C. or lower. When the main firing temperature is too low, the P2-type structure is not sufficiently formed, whereas when the main firing temperature is too high, a crystal structure other than the P2-type structure (e.g., an O3-type structure) is likely to form. The temperature raising condition from the preliminary firing temperature to the main firing temperature is not particularly limited. The main firing time is not particularly limited, either, and may be, for example, 30 minutes or longer and 10 hours or shorter. The main firing atmosphere is not particularly limited, either, and may be, for example, an oxygen-containing atmosphere, such as an atmosphere of ambient air, or an inert gas atmosphere.

### 3. Battery

A battery according to one embodiment has the above-described positive electrode active material of the disclosure. The positive electrode active material of the disclosure can be adopted as a positive electrode active material of a sodium ion battery, for example. As shown in FIG. 2, a battery 100 according to one embodiment has a positive electrode active material layer 10, an electrolyte layer 20, and a negative electrode active material layer 30, and the positive electrode active material layer 10 includes the positive electrode active material of the disclosure. The battery 100 can include a positive electrode current collector 40 and a negative electrode current collector 50. The battery 100 may be a solid-state battery or may be an aqueous battery. A solid battery refers to a battery which includes a solid electrolyte and in which presence of liquid is allowable. The battery 100 may be an all-solid-state battery that includes virtually no liquid. The configuration of the battery may be the same as the conventional one except that the positive electrode active material of the disclosure is adopted. Detailed description will be omitted here.

While one embodiment of the positive electrode active material etc. of the disclosure has been described above, various changes from the above-described embodiment can be made to the positive electrode active material etc. of the disclosure within such a range that no departure is made from the gist of the disclosure. In the following, the technology of the disclosure will be described in further detail while showing Examples, but the technology of the disclosure is not limited to the following Examples.

### 1. Production of Positive Electrode Active Material

### 1.1 Coprecipitation Synthesis of Precursor

MnSO₄·5H₂O and NiSO₄·6H₂O were weighed to a target composition ratio and dissolved in distilled water to a concentration of 1.2 mol/L to obtain a first liquid. In a separate container, Na₂CO₃ was dissolved in distilled water to a concentration of 1.2 mol/L to obtain a second liquid. Subsequently, to a reaction container with 1000 mL of pure water put therein beforehand, 500 mL of each of the first liquid and the second liquid was dripped at a speed of about 4 mL/min. After completion of the dripping, stirring was performed at room temperature, at a stirring speed of 150 rpm, for one hour. The resulting precipitate was washed with pure water and separated into a solid and a liquid by a centrifugal separator. The obtained precipitate was dried overnight at 120° C. and pulverized in a mortar, and then fine particles were removed by airflow classification. Thus, a precursor including Mn and Ni (Mn_{0.66}Ni_{0.34}CO₃) was obtained.

### 1.2 Mixing of Precursor, Na Source, and Ca Source

### 1.2.1 Examples 1 to 4

The above-described precursor, NaCO₃ as the Na source, and Ca(OH)₂ as the Ca source were mixed together in a mortar to obtain a solid mixture.

### 1.2.2 Comparative Examples 1 and 2

The above-described precursor and NaCO₃ as the Na source were mixed together in a mortar to obtain a solid mixture.

### 1.3 Firing of Solid Mixture

Firing of the solid mixture was performed inside an electric furnace using an alumina crucible in an atmosphere of ambient air (humidity 50% or higher). Specifically, the solid mixture was molded into pellets and then subjected to “first temperature raising step,” “preliminary firing step,” “second temperature raising step,” “main firing step,” and “in-furnace cooling step” as shown in Table 1 below. Thereafter, the fired object was taken out of the electric furnace at 250° C. and pulverized in a mortar in a dry atmosphere with a dew point of −30° C. or lower. Thus, an Na-containing oxide having the P2-type structure was obtained.

TABLE 1

| | | | | Temperature |
|---|---|---|---|---|
| | Start | End | | raising or |
| | temperature | temperature | Time | cooling speed |
| Step | (° C.) | (° C.) | (min) | (° C./min) |
| First temperature | 25 | 600 | 115 | 5 |
| raising step | | | | |
| Preliminary firing | 600 | 600 | 360 | 0 |
| step | | | | |
| Second temperature | 600 | 900 | 100 | 3 |
| raising step | | | | |
| Main firing step | 900 | 900 | 60 | 0 |
| In-furnace cooling | 900 | 250 | 130 | 5 |
| step | | | | |

### 2. Determination of Chemical Composition of Positive Electrode Active Material

The chemical compositions of the positive electrode active materials respectively of Examples 1 to 4 and Comparative Examples 1 and 2 were determined by an ICP analysis. Table 2 below shows their respective chemical compositions.

TABLE 2

| | | Additive element |
|---|---|---|
| | Chemical composition | doping amount x |
| Example 1 | Na_{0.8-2x}CaₓMn_{0.66}Ni_{0.34}O₂ | x = 0.025 |
| Example 2 | Na_{0.8-2x}CaₓMn_{0.66}Ni_{0.34}O₂ | x = 0.045 |
| Example 3 | Na_{0.8-2x}CaₓMn_{0.66}Ni_{0.34}O₂ | x = 0.075 |
| Example 4 | Na_{0.8-2x}CaₓMn_{0.66}Ni_{0.34}O₂ | x = 0.085 |
| Comparative Example 1 | Na_{0.8}Mn_{0.66}Ni_{0.34}O₂ | x = 0 |
| Comparative Example 2 | Na_{0.7}Mn_{0.66}Ni_{0.34}O₂ | x = 0 |

### 3. Electrochemical Measurement

### 3.1 Capacity Retention Rate (Cycle Characteristics)

The above-described positive electrode active material, PVdF as a binder, and carbon as a conduction aid were weighed to a mass ratio of positive electrode active material:PVdF:carbon=85:5:10, and were dispersedly mixed into N-methyl-2-pyrrolidone to obtain a slurry. This slurry was applied to an Al foil, and then this Al foil was pressed and vacuum-dried at 120° C. overnight to obtain a positive electrode. Using this positive electrode, a metal Na foil as a counter electrode, and a 1MNaPF₆PC solution as an electrolytic solution, a coin cell was produced. In a thermostatic bath held at 25° C., charge and discharge of the coin cell were performed in a voltage range of 2.0 to 4.5 V, at 0.1 C rate, and with the discharge capacity in the first cycle as a reference (100%), the discharge capacity retention rates in the second cycle to the fifth cycle were measured. The result is shown in Table 3 below.

TABLE 3

| | Comparative | Example | Example | Example | Example |
|---|---|---|---|---|---|
| | Example 1 | 1 | 2 | 3 | 4 |
| First | 100 | 100 | 100 | 100 | 100 |
| cycle | | | | | |
| Second | 96.2 | 94.4 | 97.5 | 99.2 | 98.2 |
| cycle | | | | | |
| Third | 90.3 | 90.9 | 93.5 | 96.8 | 95.8 |
| cycle | | | | | |
| Fourth | 84.2 | 87.2 | 88.1 | 94.6 | 94.2 |
| cycle | | | | | |
| Fifth | 78.9 | 83.6 | 82.9 | 92.2 | 92.7 |
| cycle | | | | | |

From the result shown in Table 3, it can be seen that when the Na-containing oxide having the P2-type structure is doped with Ca, the cycle characteristics improve remarkably. This is presumably because when the Na-containing oxide having the P2-type structure is doped with Ca, as this Ca functions as a pillar, collapse etc. of the Na layers is mitigated and the P2-type structure is appropriately maintained even after desorption of Na, resulting in improved cycle characteristics.

### 3.2 Discharge Capacity in First Cycle

In a thermostatic bath held at 25° C., charge and discharge of the coin cell were performed in a voltage range of 2.0 to 4.5 V, at 0.1 C rate, and the discharge capacity in the first cycle of charge and discharge was measured. The result is shown in Table 4 below.

TABLE 4

| | Additive | | Discharge |
|---|---|---|---|
| | element | Additive element | capacity |
| | type | doping amount x | (mAh/g) |
| Example 1 | Ca | 0.025 | 143.00 |
| Example 2 | Ca | 0.045 | 148.42 |
| Example 3 | Ca | 0.075 | 124.90 |
| Example 4 | Ca | 0.085 | 105.80 |
| Comparative Example 1 | None | 0 | 122.45 |
| Comparative Example 2 | None | 0 | 138.75 |

From the result shown in Table 4, the following can be said. First, a look at the result of the case where Ca doping is not performed (Comparative Examples 1 and 2) shows that the positive electrode active material in which the amount of Na in the Na-containing oxide is 0.8 (Comparative Example 1) has a lower capacity than the positive electrode active material in which the amount of Na in the Na-containing oxide is 0.7 (Comparative Example 2). One possible explanation is that, when the amount of Na included in the Na-containing oxide increases, the Na—O bond becomes stronger and the layer interval of the Na layers in the P2-type structure becomes shorter, affecting insertion and desorption of Na. Another possible explanation is that the P2-type structure collapses after desorption of Na, affecting insertion of Na. On the other hand, the positive electrode active materials according to Examples 1 to 3 have higher capacities than the positive electrode active material according to Comparative Example 1. This is presumably because, as the Na-containing oxide was doped with Ca, the Ca functioned as a pillar and stabilized the P2-type structure as described above, and the amount of Na to be desorbed increased and consequently a higher capacity was secured. While the positive electrode active material according to Example 4 has excellent cycle characteristics as described above, the capacity itself turned out to be low due to the smaller amount of Na included in the positive electrode active material. In this respect, it can be said that when a high capacity in addition to excellent cycle characteristics is desired to be secured, it is preferable that the amount of Na included in the Na-containing oxide be set to 0.65 mol or more and less than 0.80 mol (0.65≤Na/O₂<0.80) per mole of the Na-containing oxide, and that the amount of Ca included in the Na-containing oxide be set to more than 0 mol and 0.075 mol or less (0<Ca/O₂≤0.075) per mole of the Na-containing oxide.

### 4. Confirmation about Ca Doping Site

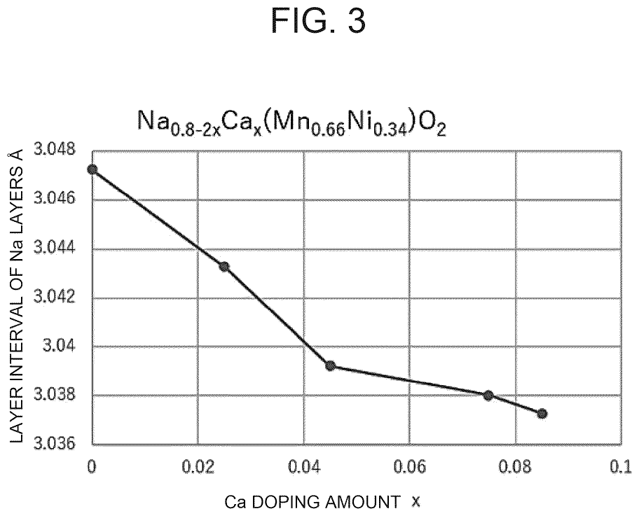

In each of the positive electrode active materials according to Examples 1 to 4 and Comparative Example 1, the interlayer distance of the Na layers in the P2-type structure was calculated by Rietveld analysis. The result is shown in FIG. 3. As shown in FIG. 3, the interlayer distance of the Na layers in the P2-type structure was largest in Comparative Example 1 in which Ca doping had not been performed, and became smaller as the Ca doping amount increased. Here, it is presumed that, since the ion radius of Ca²⁺ is larger than the ion radius of the transition metal element, the transition metal layers in the P2-type structure are not easily doped with Ca. That is, it is presumed that in Examples 1 to 4, the Na layers in the P2-type structure of the Na-containing oxide were doped with Ca, and that as the Ca functioned as a pillar, collapse etc. of the Na layers was mitigated to produce the above-described results.

### 5. Conclusion

While the positive electrode active materials having the specific chemical compositions have been illustrated in the above-described Examples, the chemical composition of the positive electrode active material is not limited to the above-described ones. In view of the results of the above-described Examples, a positive electrode active material meeting the following requirements (1) to (3) is considered to have excellent cycle characteristics.
(1) The positive electrode active material includes an Na-containing oxide.
(2) The Na-containing oxide has a P2-type structure.
(3) The Na-containing oxide includes, as constituent elements, at least: Na; Ca; at least one transition metal element among Mn, Ni, and Co; and O.

What is claimed is:

1. A positive electrode active material comprising an Na-containing oxide,
wherein the Na-containing oxide has a P2-type structure, and
wherein the Na-containing oxide includes, as constituent elements, at least:
Na
Ca;
at least one transition metal element among Mn, Ni, and Co; and
O.

2. The positive electrode active material according to claim 1,
wherein an amount of Na included in the Na-containing oxide is 0.65 mol or more and less than 0.80 mol per mole of the Na-containing oxide, and
wherein an amount of Ca included in the Na-containing oxide is more than 0 mol and 0.075 mol or less per mole of the Na-containing oxide.

3. The positive electrode active material according to claim 1, wherein the Na-containing oxide includes, as constituent elements, at least Na, Ca, Mn, Ni, and O.

4. A manufacturing method of a positive electrode active material, comprising:
obtaining a solid mixture including a precursor, an Na source, and a Ca source; and
obtaining an Na-containing oxide having a P2-type structure by firing the solid mixture,
wherein the precursor includes at least one transition metal element among Mn, Ni, and Co.

5. A battery, comprising a positive electrode active material layer, an electrolyte layer, and a negative electrode active material layer, wherein the positive electrode active material layer includes the positive electrode active material according to claim 1.
